(19) United States
(12) Patent Application Publication
(10) Pub. No.: US 2026/0356499 A1
(43) Pub. Date: Nov. 12, 2026

(54) SYSTEM AND METHOD FOR CAPTURING SPACE DEBRIS

(71) Applicants: Rockdrill Research, LLC, Austin, TX (US); Southwest Research Institute, San Antonio, TX (US)

(72) Inventors: Joseph GUZMAN, Austin, TX (US); Randall ROSE, Broomfield, CO (US); Thomas ROSE, San Antonio, TX (US); Thomas LYONS, San Antonio, TX (US); Cody PORTER, San Antonio, TX (US)

(73) Assignees: Rockdrill Research, LLC, Austin, TX (US); Southwest Research Institute, San Antonio, TX (US)

(21) Appl. No.: 19/134,390

(22) PCT Filed: Dec. 1, 2023
(86) PCT No.: PCT/US2023/082085

§ 371 Date: May 30, 2025

Related U.S. Application Data
(60) Provisional application No. 63/429,629, filed on Dec. 2, 2022.

(51) Int. Cl. B64G 1/10; B64G 1/40

(52) U.S. Cl. CPC B64G 1/1081; B64G 1/4024

(57) ABSTRACT

A system and method for capturing space debris including a satellite having a capture and arrest mechanism for space debris including a receiving chamber having a collapsible wall defining an open first end and a second open end space along a longitudinal axis. A cover is disposed over the open first end. The cover including a cover support and a plurality of cover segments hingedly secured to the cover support. A drive mechanism is operably connected to the cover to move the cover between an open and closed position, wherein movement of the cover along the longitudinal axis toward the second end causes the cover segments to move toward the closed position. A collection chamber is disposed adjacent to the receiving chamber second open end. A retention door is disposed between the collection chamber and the receiving chamber second open end, the retention door being movable between an open and closed position.

This application claims the benefit of priority to U.S. Provisional Application No. 63/429,629 filed on Dec. 2, 2022, the entire content of which is incorporated by reference herein.

This invention was made with government support under Contract Number FA945322CA075 awarded by the United States Department of Defense through the Air Force Research Laboratory. The U.S. government has certain rights in the invention.

### FIELD OF TECHNOLOGY

This disclosure relates to a system and method for capturing space debris, and more particularly, a device for entering Earth's orbit, retrieving and capturing debris and removing, or otherwise remediating, the debris from orbit.

### BACKGROUND

In preparation for future economic activity in space, concern has risen over the increasing presence of man-made space debris resultant from decades of launching and operating spacecraft. Currently, over 15,000 pieces of debris in Lower Earth Orbit (LEO) threaten the 4,000 active satellites operating in the same orbital regime. Satellite owner operators regularly conduct costly maneuver operations to avoid collisions with known pieces of debris. However, due to limitations of current sensors, it is estimated that more pieces of smaller debris either go untracked or are tracked with unreliable accuracy. This exposes satellites operating in LEO to unknown risks. This situation, until dealt with, will limit the expansion of economic activity in the space domain, the magnitude of which is projected to be over $1 trillion annually in the next 5 to 10 years.

The increasing risk posed by space debris has caused several spacecraft insurance companies to withdraw from the market, as stated in the September 2021 article in Insurance Journal entitled, “Insurers Pull Back as Risk of Satellite and Debris Collisions Surge.” This represents the growing negative commercial impact of space debris. Any day, a commercial satellite could catastrophically collide with a piece of debris, creating a total loss for the satellite owner/operator and cascading effects to customers who rely on it. In order to preserve the space environment for future economic development, the U.S. Space Force could police its own debris, setting an example for other organizations to follow. It would reduce operational risk to its own satellites, and more importantly, reduce the liability risk of uncontrolled collisions of its debris with other satellites.

Accordingly, it would be desirable to provide a system and method that is capable of targeting space debris, capturing the debris, and remediating it such that it no longer poses a threat to orbiting satellites.

### SUMMARY

The present disclosure provides a system and method for capturing space debris in orbit including a satellite having a capture and arrest mechanism for space debris including a receiving chamber having a collapsible wall defining an open first end and a second open end space along a longitudinal axis. A cover is disposed over the open first end. The cover includes a cover support and a plurality of cover segments hingedly secured to the cover support. A drive mechanism is operably connected to the cover to move the cover between an open and closed position, wherein movement of the cover along the longitudinal axis toward the second end causes the cover segments to move toward the closed position. A collection chamber is disposed adjacent to the receiving chamber second open end. A retention door is disposed between the collection chamber and the receiving chamber second open end, the retention door being movable between an open and closed position.

The present disclosure also provides a system for capturing orbiting space debris including a debris capturing satellite including a main body having a propulsion device and a capture and arrest mechanism secured to the satellite. The capture and arrest mechanism comprising a receiving chamber having a collapsible wall defining an open first end and a second open end space along a longitudinal axis. A cover is disposed over the open first end. The cover includes a cover support and a plurality of cover segments hingedly secured to the cover support. A drive mechanism is operably connected to the cover to move the cover between an open and closed position, wherein movement of the cover along the longitudinal axis toward the second end causes the cover segments to move toward the closed position. A collection chamber is disposed adjacent to the receiving chamber second open end. A retention door is disposed between the collection chamber and the receiving chamber second open end. The retention door is movable between an open and closed position. A processor is operably connected to a plurality of sensors disposed on the main body and the sensors characterize targeted space debris in at least one of size, mass, and rate of tumble, and the processor conducting a risk assessment of capture.

The present disclosure further provides a method of capturing space debris comprising: identifying space debris;
maneuvering a debris capture satellite into proximity of the targeted space debris;
activating a capture and arrest mechanism secured to the satellite, the capture and arrest mechanism comprising
   a receiving chamber having a collapsible wall defining an open first end and a second open end space along a longitudinal axis;
   a cover disposed over the open first end, the cover including a cover support and a plurality of cover segments hingedly secured to the cover support;
   a drive mechanism operably connected to the cover to move the cover between an open and closed position, wherein movement of the cover along the longitudinal axis toward the second end causes the cover segments to move toward the closed position;
   a collection chamber disposed adjacent to the receiving chamber second open end; and
   a retention door disposed between the collection chamber and the receiving chamber second open end, the retention door being movable between an open and closed position;
activating the drive mechanism to drive the cover segments into the open position;
   maneuvering the satellite within the path of the targeted space debris to permit the debris to pass through the cover opening and into the receiving chamber; and
operating the drive mechanism to cause the cover support to retract thereby moving the cover segments into the closed position.

These and other objects and advantageous aspects will become apparent from a description of exemplary embodiments with reference to the following figures.

### BRIEF DESCRIPTION OF THE DRAWINGS

FIG. 1 is a schematic representation of the space debris capture satellite with a debris capturing mechanism.

FIG. 2 is a perspective view of the debris capturing mechanism showing a shell wall in phantom.

FIG. 2A is a side elevational view of the debris capturing mechanism.

FIG. 3. is a cross-sectional view of the mechanism taken through line 3-3 of FIG. 2.

FIG. 3A is a cross-sectional view taken through line 3A-3A of FIG. 3.

FIG. 4 is a partial cross-sectional view of the debris capturing mechanism.

FIG. 4A is a partial detailed view of the debris capturing mechanism of FIG. 4.

FIG. 5 is a perspective view showing a receiving end opened with the shell wall shown in phantom.

FIG. 6 is a cross-sectional perspective view taken along the longitudinal axis Y-Y shown in FIG. 1, showing the cover in the open position.

FIG. 7 is detail view of a cam mechanism.

FIG. 8 is a perspective view showing the cover closed and the shell wall shown in phantom.

FIG. 9 is a perspective view showing the cover closed and partially retracted and the shell wall and captured debris shown in phantom.

FIG. 10 is a cross-sectional perspective view showing the cover closed and partially retracted and captured debris shown in phantom entering the collection chamber.

FIG. 11 is a risk assessment matrix for debris capture.

### DETAILED DESCRIPTION:

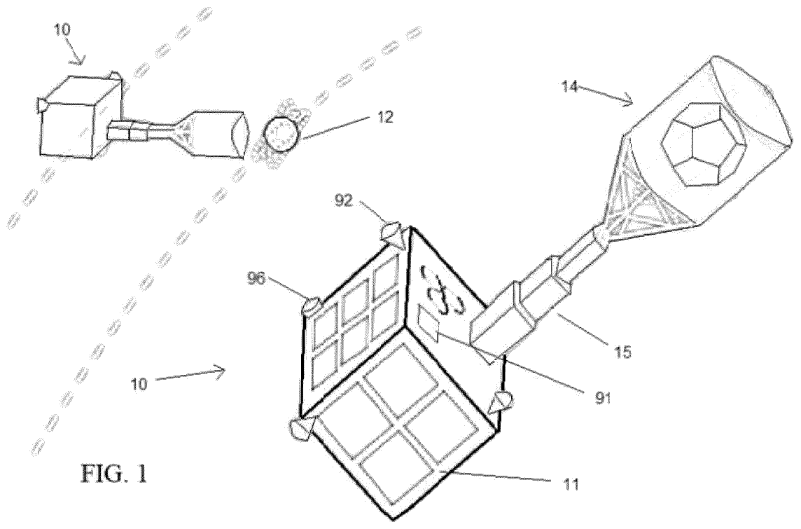

With reference to FIG. 1, the system of the present disclosure includes an Earth-orbiting debris capture satellite 10 specifically designed to collect and dispose of small pieces of space debris 12 of approximate size between 1 and 10 cm in diameter. The debris capture satellite 10 would preferably be a microsatellite (<200 kg) about the size of a dishwashing machine equipped with a main body 11 including solar arrays, batteries, propulsion tank(s), attitude control subsystems, inertial reference units, a central computing unit including a processor, sensors, and a capture and arrest mechanism 14.

With reference to FIGS. 1-5, the capture and arrest mechanism 14 includes a capture device 16 for collecting the debris 12 and a collection chamber 18 into which the captured space debris 16 is retained. In one embodiment, the capture and arrest mechanism 14 may be fixedly secured to a main body 11 of the satellite (FIG. 1). In an alternative embodiment, the capture and arrest mechanism 14 may be secured to the main body by a robotic arm 15 (FIG. 1) having a telescoping feature of a type know in the art. The capture device 16 includes an annular base 19 having an annular shell wall 20 extending therefrom to form an interior 22. The base 19 is secured to a support frame 24. Opposed from the base 19 is a cover 26 which is selectively movable between an open and closed position. The cover 26 is formed of a plurality of cover segments 28 hingedly attached to a cover support 30. The cover support 30 is a ring-shaped structure having an outer diameter less then an interior diameter of the shell wall 20. Between the base 19 and the cover support 30 is a debris receiving chamber 32 having an open first end 34 and an open second end 36. The cover support 30 defines an opening 31 adjacent debris receiving chamber first end 34. Therefore, debris 12 passing through the cover support 30 enters the receiving chamber 32.

The debris receiving chamber 32 may have an adjustable volume which allows it to collapse and expand as described below. In one embodiment, the receiving chamber 32 is formed of a flexible material, such as Kevlar reinforced silica cloth The chamber 32 has a wall 33 formed of a plurality of concentric convolutions 33a such that it is collapsible along an axial direction. Y-Y thereof. The receiving chamber 32 may have a frustoconical shape wherein its diameter decreases as the receiving chamber 32 extends from its first end 34 to its second end 36. In this way, the receiving chamber 32 acts as a funnel to aid in collecting the debris 12.

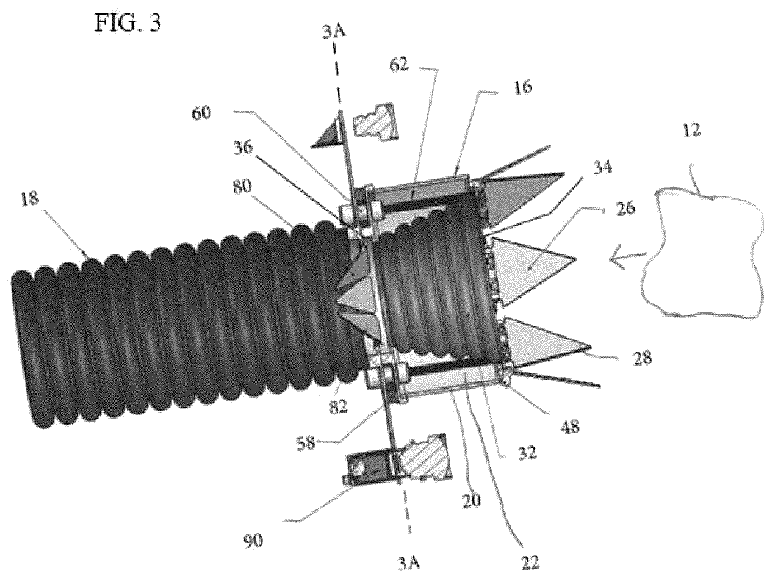

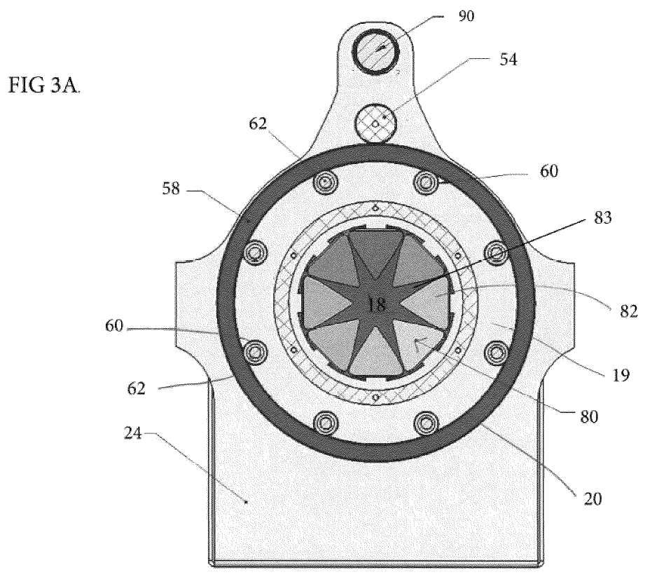

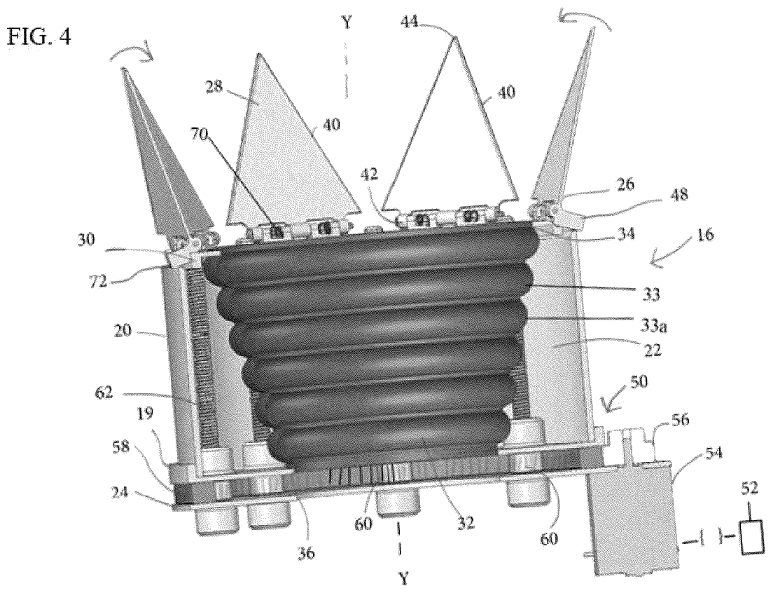

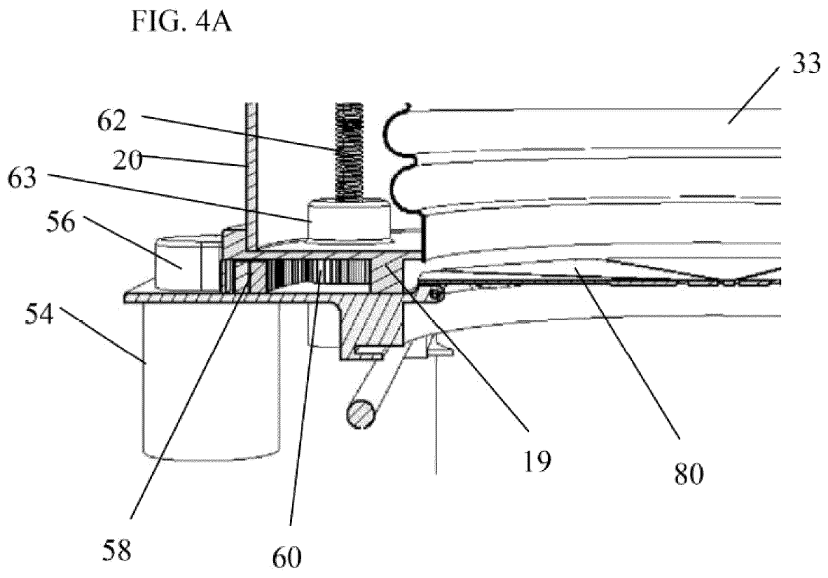

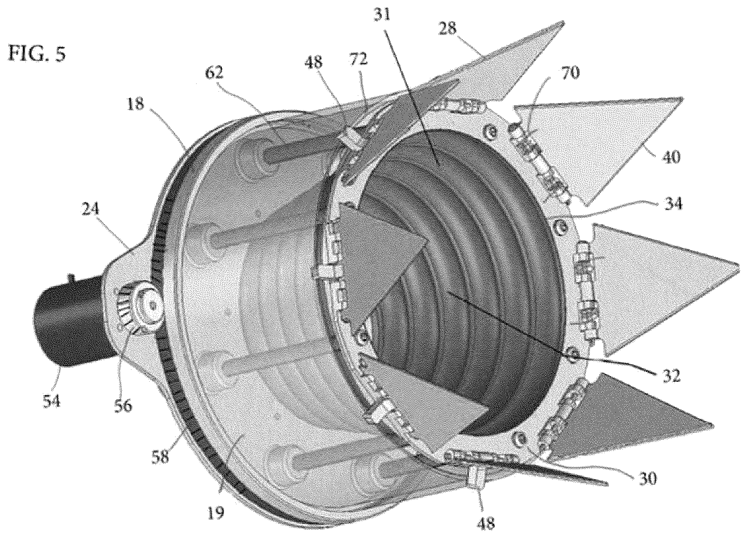

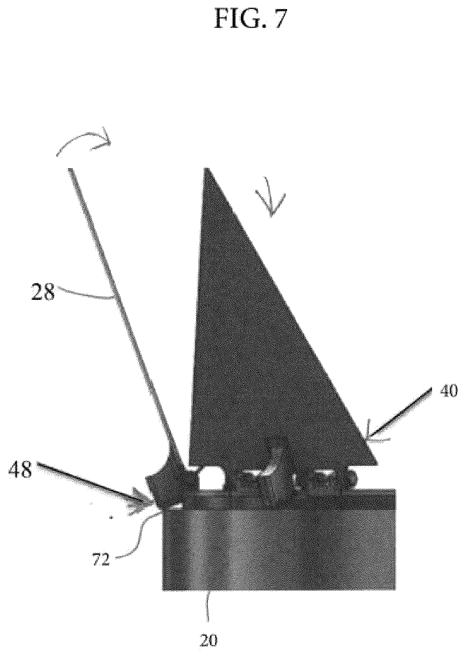

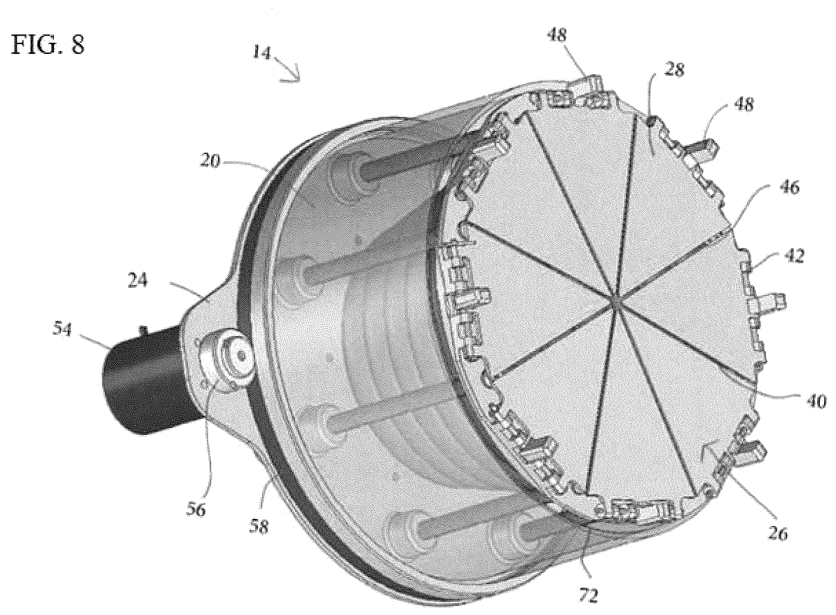

With reference to FIGS. 3, 4, and 8, in one embodiment, the cover segments 28 may be generally triangular in shape having three joined side edges 40 and pivotable about a hinge 42 between an open and closed position. The cover segments 28 may each be hinged along one of the side edges 40 with a point 44 of the triangle shaped member projecting radially inwardly. When the cover segments 28 are in the open position, as shown in FIG. 5, access to the receiving chamber 32 is permitted, and the targeted debris 12 can travel pass the cover 26 and into the receiving chamber 32. When the cover segments 28 are in the closed position, as shown in FIG. 8, the cover segment side edges 40 lie adjacent to each other such that access in or out of the receiving chamber 32 is prevented. A gap 46 (FIG. 8) may remain between the segment side edges when in the closed position such that they do not touch each other. In this way, binding between the cover segments 28 can be mitigated. As shown in FIGS. 4, 7 and 8, each cover segment 28 includes a cam 48 protruding orthogonally therefrom and disposed adjacent the hinge 42. The cam 48 is used to move the cover segments to the closed position as will be described below.

With particular reference to FIGS. 4 and 4A, the cover segments 28 are actuated by a drive mechanism 50 operably connected to a drive controller 52. The drive controller 52 may include a motor controller and processor able to process software and execute instructions in a manner known in the art. The drive mechanism 50 includes a drive motor 54 attached to a drive gear 56. The drive gear 56 is fixedly secured to the support frame 24. The drive gear 56 is meshed with a ring gear 58 disposed below the base 19. The ring gear 58 meshes with a plurality of radially spaced planetary gears 60 rotatably mounted on the support frame 24. Each planetary gear 60 is connected to a threaded drive shaft 62, which is threadedly engaged with an internally threaded sleeve 63 that is fixed to the base 19. A distal end 64 of each drive shaft is rotatably secured to the cover support 30. Upon activation of the drive motor 54, the drive gear 56 rotates the ring gear 58 which in turn causes the planetary gears 60 to rotate. This results in the threaded drive shafts 62 rotating. As the drive shafts 62 rotate within fixed sleeves 63, the cover support 30 moves along the axial direction Y-Y relative to the base 19. Rotation of the motor 54 in a first direction causes the cover support 30 to move toward the base 19, and rotation of the motor 54 in the opposite direction causes the cover support 30 to move away from the base 19.

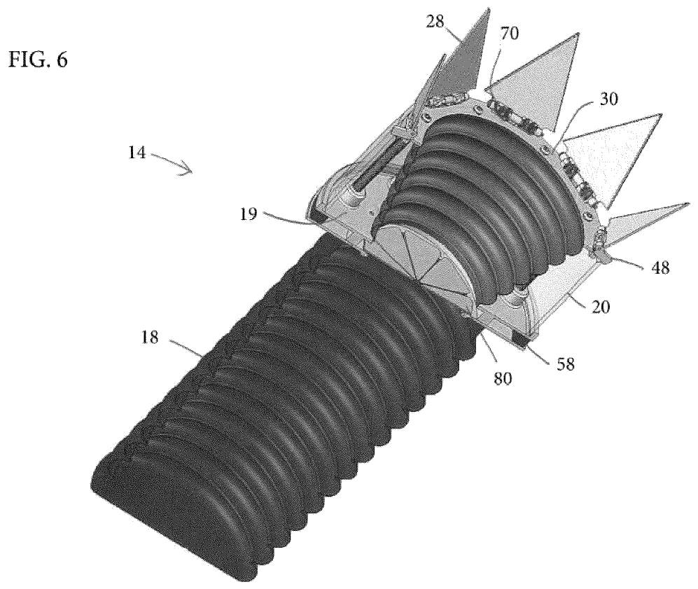

With reference to FIGS. 4, 6, and 7, movement of the cover support 30 by the drive mechanism 50 causes the cover segments 28 to move between the open and closed position. This is achieved by a cam action resulting from a mechanical interaction between the cams 48, extending from each of the cover segments 28, and the shell wall 20. The cover segments 28 are biased by a hinge spring 70 toward the open position. When the cover support 30 is disposed above a top rim 72 of the shell wall, the cams 48 extend beyond the wall 20 thereby allowing the segments 28 to pivot to the fully open position as shown in FIG. 4. It is in this position that the capture and arrest mechanism 14 is able to receive and retain a piece of space debris 12.

With reference to FIG. 8, when the targeted debris 12 enters the receiving chamber 32, the cover 26 is closed. This is achieved by the controller 52 actuating the drive motor 54 such that the threaded drive shafts 62 are rotated, in the manner described above, and the cover support 30 is driven along axis Y-Y toward the base 19. This movement draws the cover support below the shell wall top rim 72 such that the cams 48 on the cover segments engage the wall 20. This engagement causes the cover segments 28 to pivot, against the bias of the spring 70, toward the closed position. This movement also pushes on the receiving chamber causing it's wall 33 to collapse and the chamber's volume to be reduced. When the cover is closed, the debris 12 is secured within the receiving chamber 32.

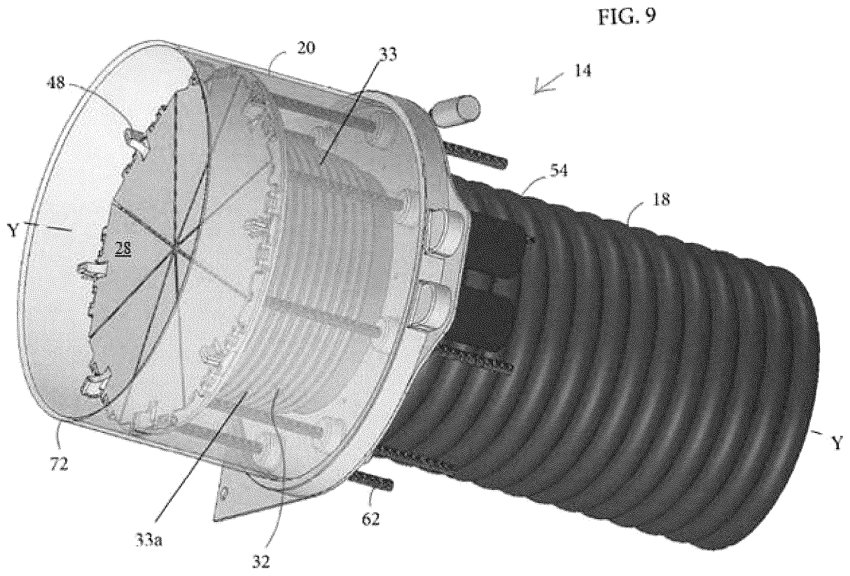

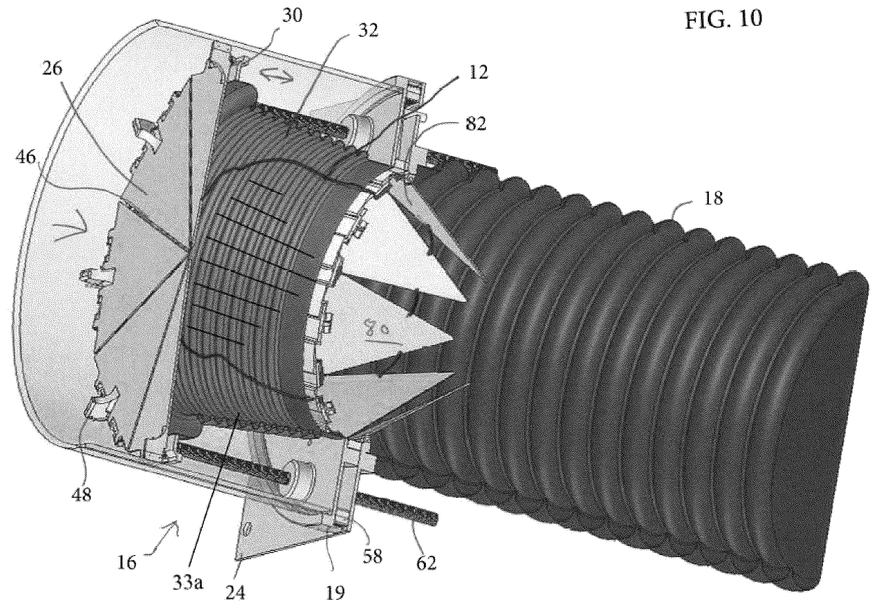

With reference to FIGS. 9 and 10, the capture and arrest mechanism 14 further moves the debris 12 into the collection chamber 18. At the base of the receiving chamber is a retention door 80 formed of a plurality of door segments 82. The door segments 82 may have a triangular shape similar to the cover segments 26 described above. Each door segment 82 is hingedly attached to the support frame 24 and is biased toward a closed position by a hinge spring. This retention door 80 forms the separation between the receiving chamber and the collection chamber 18. As the cover support, and door segments thereon, are driven in a retracted direction toward the base plate by the drive mechanism, the captured debris 12 is forced into engagement with the retention door segments 82. This causes the segments 82 to pivot toward their open position creating an opening 83 (FIG. 3A) for the debris 12 to pass there through and into the collection chamber 18. Once the debris 12 has based by the segment, the biasing action created by the hinge springs causes the door segments 82 to return to their closed position, thus retaining the debris 12 within the collection chamber 18.

After the debris 12 is secured in the collection chamber 18, the capture and arrest mechanism may be reset to capture and receive additional debris. To do this, the controller would send a signal to activate the drive motor 54. The cover support would then move away from the base plate in an extended direction thereby expanding the interior chamber. When the cover support and the cams 48 extend beyond the rim, each door segment would be free to pivot into the open position under the biasing force of the spring 70.

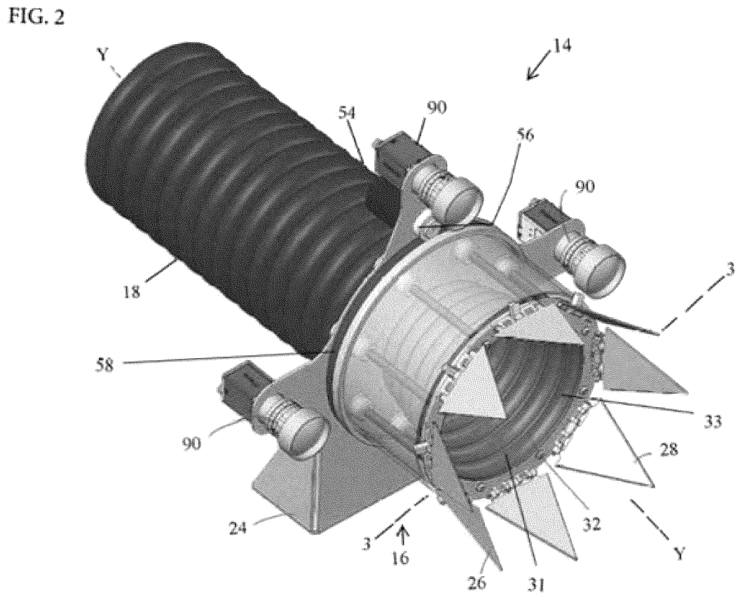

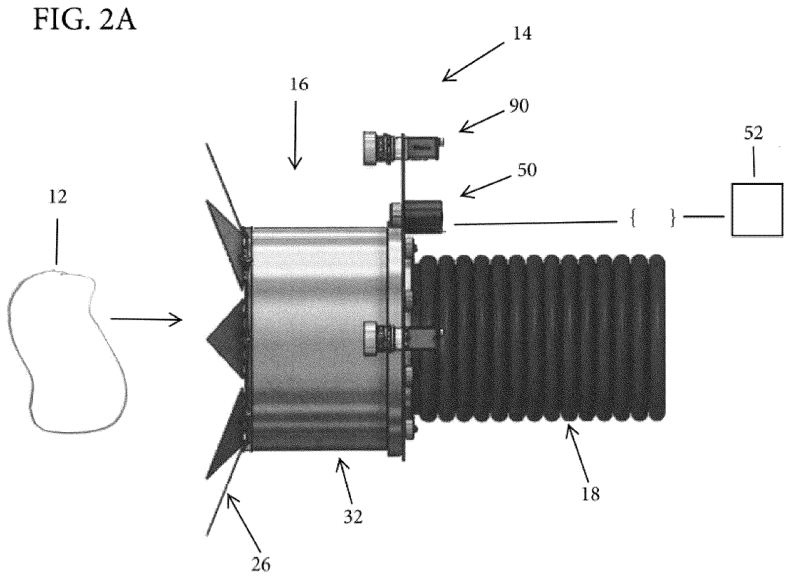

Referring to FIGS. 1 and 2, the capture and arrest mechanism 14 may further include a plurality of sensors 90 used to detect the debris 12 and provide data to permit the positioning of the satellite 10 to receive the debris. In one embodiment, the sensors 90 may include a plurality of cameras, LIDAR, electro-optical sensors, infrared and UV sensors. As shown in FIG. 2, three cameras 90 may be secured to the support frame 24 such that they are radially spaced around the capture device 14. The cameras will be neuromorphic near infrared and visible type sensors. The cameras 90 work in cooperation to provide data to assess the location, speed and direction of the debris to be capture, i.e., the targeted debris 12. The data collected by the cameras is fed into a control system 91 positioned on the satellite 10. The satellite control system 91 will then take the necessary action such has firing control boosters 92 to adjust the orientation and speed of the satellite. Once the location and dynamic characteristic of the debris 12 is determined, the information can be relayed to a base station on Earth or in orbit.

In operation, the debris capture satellite 10 is launched via a commercial space launch vehicle into the inclination, or orbital plane, of the selected debris 12 to be removed. Due to the debris capture satellite's 10 relatively small size, the debris capture satellite 10 can ride share into orbit with other small spacecraft, saving on launch costs. The debris capture satellite 10 is capable of limited maneuvering into adjacent orbital planes using known satellite propulsion and guidance systems, where follow-on debris removal missions may occur.

Once in the orbital plane with the targeted debris 16, the debris capture satellite 10 modifies its orbit to match that of the targeted debris by boosting or de-boosting with its on-board propulsion systems. The debris capture satellite conducts a far rendezvous with target debris, at a range of approximately 30 km. The debris capture satellite 10 uses on-board sensor pack including a plurality of sensors such the cameras 30 to observe the target debris 12. The resultant data that is obtained is used to calculate maneuver commands to safely bring the debris capture satellite to a close rendezvous at a range of less than 10 meters, where it will conduct proximity operations. The debris capture satellite 10 employs on-board sensors to characterize the target debris in terms of size, mass, rate of tumble, and other factors. This data is used by the central computing unit to conduct a risk assessment of capture.

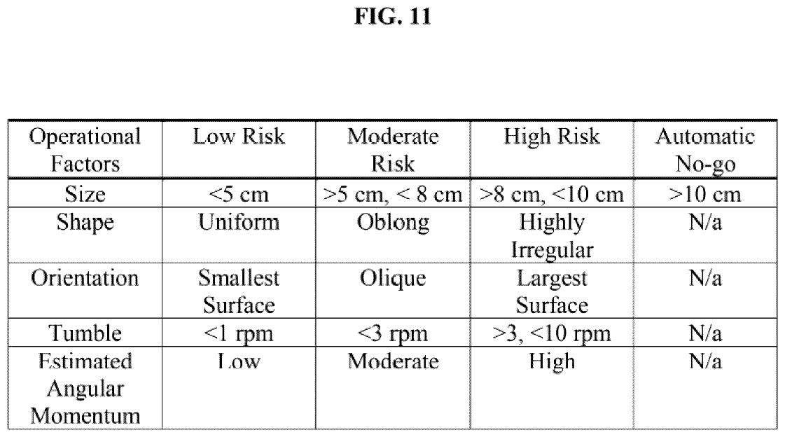

With reference to FIG. 11, the sensor package and associated onboard artificial intelligence and machine learning AI/ML software assesses the piece of debris 12 based on 5 factors: Size, shape, orientation, tumble and estimated angular momentum. If a moderate or high level of risk is assessed, risk mitigaiton proceedures are instituted including repositioning the satilite 10 or maneuvering it to a better position relative to the debris 12. A reassessment then takes place. Once the lowest capture risk is achieved and no further mitigation can be done, the final assessment is made. The greatest risk assessment remaining for any of the factors then becomes the overall operational risk of the debris capture. If assessed risk is low, then the operation proceeds automatically unless halted by an operator. A moderate risk operation requires the approval of an operator before continuing. A high risk operation will be automatically aborted unless overridden by an operator. The values provided in FIG. 11 are exemplary, and it is contemplated that parameters of different vlaues could be used depending on the configuration of the satilite 10.

If risk of debris capture is deemed acceptable, the debris capture satellite 10 will use its on-board propulsion systems and the capture and arrest mechanism 14 to first encircle, grasp, and gain control of the targeted debris 12. The debris capture satellite 10 uses on-board propulsion and inertial reference units to arrest any tumble imparted to the spacecraft from the debris, re-orient itself, and prepare for de-orbit.

When the target is with an acceptable proximity to the satellite 10, the controller 52 will activate the drive mechanism 50 to drive the cover segments 28 into the open position in the manner as described above. The satellite 10 will be maneuvered within the path of the debris such that it will pass through the cover opening and into the receiving chamber 32. Once the target debris 12 is in the receiving chamber 32, the drive mechanism 50 will cause the cover support 30 to move in a retracted direction, thereby moving the cover segments 28 into the closed position such as shown in FIG. 8. As the cover 26 is further driven in a retracted direction, the receiving chamber 33 walls collapse, and the cover 26 moves the debris 12 into contact with the retention door 82. The spring loaded door segments 82 of the retention door 80 will pivot toward the collection chamber interior, thereby expanding the opening 83 into the collection chamber 18. As the cover 26 continues to be moved toward the collection chamber 18, the debris 12 will be moved past the retention door 80 and the door segment 82 will pivot back to the closed position. The captured space debris 12 will thus be securely held in the collection chamber 18.

In one embodiment, after capture, the debris capture satellite 10 conducts a de-boost maneuver to lower its orbital altitude to a point where the debris 12 can be jettisoned for a safe re-entry and the debris capture satellite 10 can safely boost and return to a sustainable orbit. If the debris capture satellite 10 retains enough propulsion capability, it can conduct a rendezvous with its next debris target and repeats the capture process.

Alternatively, after the debris 12 is captured, the debris capture satellite 10 may be directed to an in orbit collection station and the debris 12 may be deposited into the collection station. The debris 12 may then be processed for recycling or repurposing in space. Due to the significant cost of delivering material from the ground into orbit, in-orbit processing of material already in orbit can desirable.

If the debris capture satellite 10 requires additional fuel, it maneuvers to a commercial on-orbit re-fueling satellite, such as Orbit Fab, Inc.'s on-orbit fuel depot. The debris capture satellite 10 may include an integrated refueling and docking interface 96 such as a type provided by OrbitFab, known as the Rapidly Attachable Fluid Transfer Interface (RAFTI) , to receive fuel. After completing refueling operations, the debris capture satellite 10 returns to operations and far rendezvous with subsequent space debris target 12.

The debris capture satellite's 10 small size helps to reduce launch and operational costs. This feature, when combined with a concept for multiple debris capture satellites operating together (FIG. 1), affords the opportunity for economies of scale to reduce costs and generate return on investment. Active Debris Remediation not only reduces operational risk to satellites, it also creates opportunities for Satellite Insurers and Underwriters to offer affordable insurance products to their customers, and fosters a sustainable space environmental ecology where future economic activity continues to evolve.

In the foregoing description of the embodiments or aspects, various features are grouped together in a single embodiment for the purpose of streamlining the disclosure. This method of disclosure is not to be interpreted as reflecting that the claimed embodiments or aspects have more features than are expressly recited in each claim. Rather, as the following claims reflect, inventive subject matter lies in less than all features of a single disclosed embodiment or aspect. Thus the following claims are hereby incorporated into the Detailed Description, with each claim standing on its own as a separate example embodiment or aspect. It is contemplated that various embodiments or aspects described herein can be combined or grouped in different combinations that are not expressly noted in the Detailed Description. Moreover, it is further contemplated that claims covering such different combinations can similarly stand on their own as separate example embodiments or aspects, which can be incorporated into the Detailed Description.

1. A capture and arrest mechanism for space debris comprising:
a receiving chamber having a collapsible wall defining an open first end and a second open end space along a longitudinal axis;
a cover disposed over the open first end, the cover including a cover support and a plurality of cover segments hingedly secured to the cover support;
a drive mechanism operably connected to the cover to move the cover between an open and closed position, wherein movement of the cover along the longitudinal axis toward the second end causes the cover segments to move toward the closed position;
a collection chamber disposed adjacent to the receiving chamber second open end; and
a retention door disposed between the collection chamber and the receiving chamber second open end, the retention door being movable between an open and closed position.

2. The mechanism as defined in claim 1, further including a shell wall extending around the receiving chamber, the cover segments each including a cam extending therefrom, the cam being engageable with the shell wall upon movement of the cover toward the second end, wherein the engagement urges the cover segments toward the closed position.

3. The mechanism as defined in claim 1, wherein the cover segments are each biased toward the open position by a biasing device.

4. The mechanism as defined in claim 1, wherein the retention door includes a plurality of door segments hingedly secured to the cover support, the segments being biased toward a closed position.

5. The mechanism as defined in claim 1, wherein the collapsible wall was a plurality of concentric convolutions.

6. The mechanism as defined in claim 1, wherein the drive mechanism includes a plurality of threaded shafts extending between the cover and a frame disposed between the receiving chamber and the collection chamber, the threaded shafts being operably connected to a rotary drive.

7. The mechanism as defined in claim 6, wherein the threaded shafts are each operably connected to a planetary gear which is operably connected to a ring gear, the ring gear being driven by the drive motor, wherein rotation of the drive motor causes the threaded shafts to rotate.

8. The mechanism as defined in claim 1, wherein the plurality of cover segments are each triangle-shaped and one edge of each cover segment is hingedly secured to the cover support and a point of each of the plurality of cover segments extends radially inward.

9. The mechanism as defined in claim 1, wherein the plurality of cover segments are each separated from each other by a space.

10. A system for capturing orbiting space debris comprising:
a debris capturing satellite including a main body having a propulsion device;
a capture and arrest mechanism secured to the satellite;
the capture and arrest mechanism comprising a receiving chamber having a collapsible wall defining an open first end and a second open end space along a longitudinal axis;
a cover disposed over the open first end, the cover including a cover support and a plurality of cover segments hingedly secured to the cover support;
a drive mechanism operably connected to the cover to move the cover between an open and closed position, wherein movement of the cover along the longitudinal axis toward the second end causes the cover segments to move toward the closed position;
a collection chamber disposed adjacent to the receiving chamber second open end;
a retention door disposed between the collection chamber and the receiving chamber second open end, the retention door being movable between an open and closed position; and
a processor operably connected to a plurality of sensors disposed on the main body, the plurality of sensors characterizing targeted space debris in at least one of size, mass, orientation rate of tumble and estimated angular momentum, and the processor conducting a risk assessment of capture.

11. The system as defined in claim 10, wherein the processor conducts a risk assessment of capture and responsive to a determination of a safe capture condition, the processor controls the propulsion device to maneuver the debris capture satellite into a capture position adjacent the targeted space debris.

12. The system as defined in claim 11, wherein the capture and arrest mechanism is secured to the main body by a robotic arm.

13. The system as defined in claim 10, wherein the main body has a refueling port adapted to operably couple to an orbiting re-fueling satellite.

14. The system as defined in claim 10, wherein the processor causes the propulsion device to activate after capture of the targeted space debris to stabilize the debris capturing satellite.

15. The system as defined in claim 14, wherein the processor causes the propulsion device to activate to lower an orbital altitude of the debris capturing satellite to a release altitude where the captured space debris can be jettisoned for a safe re-entry.

16. The system as defined in claim 10, wherein the processor causes the propulsion device to activate to maneuver the debris capturing satellite into proximity of a collection station in orbit and the processor causes the debris capturing satellite to transfer the captured debris to the collection station.

17. The system as defined in claim 16, wherein the processor causes the capture and arrest mechanism to release the captured debris when the satellite reaches a release altitude.

18. The system as defined in claim 17, wherein the processor causes the propulsion device to activate to boost the debris capturing satellite to a predetermined sustainable orbit.

19. The system as defined in claim 10, wherein the processor, upon a determination of an unsafe capture condition, controls the propulsion device to avoid an interaction with the targeted space debris.

20. A method of capturing space debris comprising:
identifying space debris;
maneuvering a debris capture satellite into proximity of the targeted space debris;
activating a capture and arrest mechanism secured to the satellite, the capture and arrest mechanism comprising a receiving chamber having a collapsible wall defining an open first end and a second open end space along a longitudinal axis;
a cover disposed over the open first end, the cover including a cover support and a plurality of cover segments hingedly secured to the cover support;
a drive mechanism operably connected to the cover to move the cover between an open and closed position, wherein movement of the cover along the longitudinal axis toward the second end causes the cover segments to move toward the closed position;
a collection chamber disposed adjacent to the receiving chamber second open end; and
a retention door disposed between the collection chamber and the receiving chamber second open end, the retention door being movable between an open and closed position;
activating the drive mechanism to drive the cover segments into the open position;
maneuvering the satellite within the path of the targeted space debris to permit the debris to pass through the cover opening and into the receiving chamber; and
operating the drive mechanism to cause the cover support to retract thereby moving the cover segments into the closed position.

21. The method as defined in claim 20, further including moving the cover plate to cause the walls of the receiving chamber to collapse and moving the space debris into contact with and past a retention door and into the collection chamber, and wherein after capture, the debris capture satellite conducts a de-boost maneuver to lower its orbital altitude and the debris is jettisoned, and after capture, the debris capture satellite is maneuvered to an orbiting station and the debris is transfer to the station.

22. (canceled)

23. (canceled)
